(19) United States
(12) Patent Application Publication
(10) Pub. No.: US 2023/0185919 A1
(43) Pub. Date: Jun. 15, 2023

(54) SYSTEM AND PROCESS USING HOMOMORPHIC ENCRYPTION TO SECURE NEURAL NETWORK PARAMETERS FOR A MOTOR VEHICLE

(71) Applicant: GM Global Technology Operations LLC, Detroit, MI (US)

(72) Inventor: Jacob Alan Bond, Rochester Hills, MI (US)

(21) Appl. No.: 17/551,763

(22) Filed: Dec. 15, 2021

(51) Int. Cl. G06F 21/57; H04L 9/00; G06F 21/60; G06N 3/10

(52) U.S. Cl. CPC G06F 21/57; H04L 9/008; G06F 21/602; G06N 3/10

(57) ABSTRACT

A computer is provided for a system of a motor vehicle, with the system including one or more perception sensors generating sensor data and one or more output devices performing an action, in response to the output device receiving an output signal. The computer includes one or more processors coupled to the perception sensor and the output device, with the processor having a Rich Execution Environment (REE) and a Trusted Execution Environment (TEE). The computer further includes a non-transitory computer readable storage medium (CRM) including instructions such that the at least one processor is programmed to: receive the sensor data from the perception sensor; transfer the sensor data from the REE to the TEE; homomorphically encrypt the sensor data in the TEE; and calculate the encrypted output based on the encrypted sensor data in the REE and a plurality of weights of a homomorphically encrypted neural network in the REE.

### INTRODUCTION

The present disclosure relates to neural networks, and more particularly to a system and process using homomorphic encryption to secure neural network parameters for a motor vehicle.

Automotive manufacturers are developing autonomous vehicles with Neural Networks (NNs) for their analytic and predictive capabilities. More specifically, autonomous vehicles can collect input data from sensors, process the input data, and then use Deep Neural Network (DNN) models for controlling the vehicle. Two primary types of DNNs used to build models include Convolutional Neural Networks (CNNs) and Recurrent Neural Networks (RNNs).

While traditional encryption systems encrypt the weights of the DNN to avoid model extraction attacks, the encrypted DNN is still decrypted before each time that the DNN is utilized, leaving the DNN present in memory in an unencrypted state. Attempting to use a Trusted Execution Environment (TEE) to secure the memory into which the DNN is loaded is problematic due to the limited resources, both memory and processor capability, available to the TEE. Running a DNN in a TEE, e.g., at 30 frames per second, can be a bottleneck, particularly with large-scale real-time perception processing. Furthermore, existing encryption systems may not encrypt the output, which allows adversaries to reverse engineer the NN and Artificial Intelligence (Al) based on the known input/output pairs.

Thus, while existing systems with DNNs achieve their intended purpose, there is a need for a new and improved system with DNNs that addresses these issues.

### SUMMARY

According to several aspects of the present disclosure, a computer is provided for a system of a motor vehicle for sensing its environment and acting. The system includes one or more perception sensors generating sensor data and one or more output devices performing an action, in response to the output device receiving an output signal. The computer includes one or more processors coupled to the perception sensor and the output device, with the processor having a Rich Execution Environment (REE) and a Trusted Execution Environment (TEE). The computer further includes a non-transitory computer readable storage medium (CRM) including instructions, such that the processor is programmed to receive, in the REE, the sensor data from the perception sensor. The processor is further programmed to use a homomorphically encrypted neural network in the REE to calculate an encrypted output based on the sensor data in the REE and a plurality of weights. The processor is further programmed to transfer the encrypted output from the REE to the TEE and homomorphically decrypt the encrypted output in the TEE. The processor is further programmed to transfer the decrypted output from the TEE to the REE.

In one aspect, the REE requires a first amount of memory, and the TEE is a secured space and requires a second amount of memory that is smaller than the first amount of memory of the REE.

In another aspect, the processor is further programmed to transfer the sensor data from the REE to the TEE and homomorphically encrypt the sensor data in the TEE. The processor is further programmed to transfer the encrypted sensor data from the TEE to the REE, such that the processor calculates the encrypted output based on the encrypted sensor data.

In another aspect, the processor is further programmed to post-process the decrypted output in the TEE.

In another aspect, the processor is further programmed to generate the output signal in the REE based on the decrypted output, such that the output device performs the action in response to the output device receiving the output signal from the processor.

In another aspect, the processor is further programmed to initialize the system where the processor homomorphically encrypts a non-encrypted neural network in the TEE to produce the homomorphically encrypted neural network. The processor is further programmed to transfer the homomorphically encrypted neural network from the TEE to the REE.

In another aspect, the processor is further programmed to pre-process the sensor data in the TEE.

In another aspect, the processor is further programmed to homomorphically encrypt the pre-processed sensor data in the TEE.

In another aspect, the sensor data is an image from the camera, and pre-processing the sensor data includes converting an image from an RGB format to a distinct format such as YUV format or a proprietary image format.

According to several aspects of the present disclosure, a system for a motor vehicle includes one or more perception sensors attached to the motor vehicle and generating sensor data. The system further includes one or more computers coupled to the perception sensors. The computer includes one or more processors coupled to the perception sensor, with the processor having a Rich Execution Environment (REE) and a Trusted Execution Environment (TEE). The computer further includes a non-transitory computer readable storage medium (CRM) including instructions, such that the processor is programmed to receive, in the REE, the sensor data from the perception sensor. The processor is further programmed to use a homomorphically encrypted neural network in the REE to calculate an encrypted output based on the sensor data in the REE and a plurality of weights. The processor is further programmed to transfer the encrypted output from the REE to the TEE and homomorphically decrypt the encrypted output in the TEE. The processor is further programmed to transfer the decrypted output from the TEE to the REE. The system further includes one or more output devices, which are coupled to the processor and perform an action in response to the output device receiving an output signal from the processor.

In one aspect, the processor is further programmed to initialize the system where the processor homomorphically encrypts a non-encrypted neural network in the TEE to produce the homomorphically encrypted neural network. The processor is further programmed to transfer the homomorphically encrypted neural network from the TEE to the REE.

In another aspect, the perception sensor includes one or more cameras, lidar sensors, radar sensors, global navigation satellite devices, inertial measuring units (IMUs), and/or ultrasonic sensors.

In another aspect, the processor is further programmed to pre-process the sensor data in the TEE and homomorphically encrypt the pre-processed sensor data in the TEE.

In another aspect, the sensor data includes an image in an RGB format received from the camera, and pre-processing the sensor data includes converting the image from the RGB format to a distinct format such as YUV format or other suitable image format.

In another aspect, the output device includes a lateral/longitudinal control module for controlling a lateral movement and/or a lateral movement of the motor vehicle, in response to the lateral/longitudinal control module receiving the output signal from the processor.

In another aspect, the processor is further programmed to transfer the sensor data from the REE to the TEE and homomorphically encrypt the sensor data in the TEE. The processor is further programmed to transfer the encrypted sensor data from the TEE to the REE, such that the processor calculates the encrypted output based on the encrypted sensor data.

In another aspect, the processor is further programmed to post-process the decrypted output in the TEE.

In another aspect, the processor is further programmed to generate the output signal in the REE based on the decrypted output, such that the output device performs the action in response to the output device receiving the output signal.

According to several aspects of the present disclosure, a process is provided for operating a system for a motor vehicle. The system includes one or more perception sensors attached to the motor vehicle, one or more output devices attached to the motor vehicle, and one or more computers coupled to the perception sensor and the output device. Each computer includes one or more processors and a non-transitory computer readable storage medium storing instructions. The process includes generating, using the perception sensor, sensor data. The process further includes receiving, using the TEE of the processor, the sensor data from the perception sensor. The process further includes transferring, using the processor, the sensor data from the TEE to the REE. The process further includes homomorphically encrypting, using the processor, the sensor data in the TEE. The process further includes transferring, using the processor, the encrypted sensor data from the TEE to the REE. The process further includes using a homomorphically encrypted neural network in the REE to calculate an encrypted output based on the encrypted sensor data in the REE and a plurality of weights. The process further includes performing, using the output device, an action in response to the output device receiving an output signal from the processor.

In one aspect, the process further includes initializing, using the processor, the system where the processor homomorphically encrypts a non-encrypted neural network in the TEE to produce the homomorphically encrypted neural network. The process further includes transferring the homomorphically encrypted neural network from the TEE to the REE. The process further includes pre-processing, using the processor, the sensor data in the TEE, in response to the processor transferring the sensor data from the REE to the TEE. The process further includes homomorphically encrypting, using the processor, the pre-processed sensor data in the TEE, in response to the processor pre-processing the sensor data in the TEE. The process further includes transferring, using the processor, the encrypted output from the REE to the TEE, in response to the processor calculating the encrypted output. The process further includes homomorphically decrypting, using the processor, the encrypted output in the TEE in response to the processor transferring the encrypted output from the REE to the TEE. The process further includes post-processing, using the processor, the decrypted output in the TEE, in response to the processor homomorphically decrypting the encrypted output. The process further includes transferring, using the processor, the decrypted output from the TEE to the REE, in response to the processor post-processing the decrypted output. The process further includes generating, using the processor, the output signal in the REE based on the decrypted output, such that the output device performs the action in response to the output device receiving the output signal.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of one example of a motor vehicle having a system with one or more perception sensors, an output device, and a computer that has a processor with a Trusted Execution Environment (TEE) for homomorphically encrypting a deep neural network, an input, and/or an output.

FIG. 2 is a block diagram of one-non-limiting example of the computer of FIG. 1.

FIG. 3 is a diagram of a non-limiting example of a deep neural network of the computer of FIG. 2.

FIG. 4 is a flow chart of one-non-limiting example of a process of operating the system of FIG. 1.

### DETAILED DESCRIPTION

The following description is merely exemplary in nature and is not intended to limit the present disclosure, application, or uses. Although the drawings represent examples, the drawings are not necessarily to scale and certain features may be exaggerated to better illustrate and explain a particular aspect of an illustrative example. Any one or more of these aspects can be used alone or in combination within one another. Further, the exemplary illustrations described herein are not intended to be exhaustive or otherwise limiting or restricting to the precise form and configuration shown in the drawings and disclosed in the following detailed description. Exemplary illustrations are described in detail below.

The present disclosure describes one non-limiting example of a computer that improves network security by preventing model extraction attacks on Deep Neural Networks (DNNs) and securing the DNNs and their output. In addition, the computer optimizes network performance by increasing the speed of utilizing homomorphically encrypted DNNs. As described in detail below, the computer includes a processor with a Trusted Execution Environment (TEE) for homomorphically encrypting the DNN and the output. The processor further includes a Rich Execution Environment (REE) for utilizing the DNN to build and utilize a model for controlling any suitable system of a motor vehicle. The REE requires a first amount of memory, and the TEE is secured and requires a second amount of memory that is smaller than the first amount of memory, such that the REE operates the homomorphically encrypted DNN at a first speed, which is faster than a second speed in which the TEE can operate. Furthermore, the TEE is a more secure area of the processor as compared to the REE. The combined use of homomorphic encryption and the operation of the homomorphically encrypted DNN on the REE improves network security and increases the operating speed of the homomorphically encrypted DNN. While the present disclosure is directed to a computer for a system of a motor vehicle, it is contemplated that the computer can be associated with any suitable system unrelated to automotive vehicle environments, including but not limited to a robot, a security camera, and a security system.

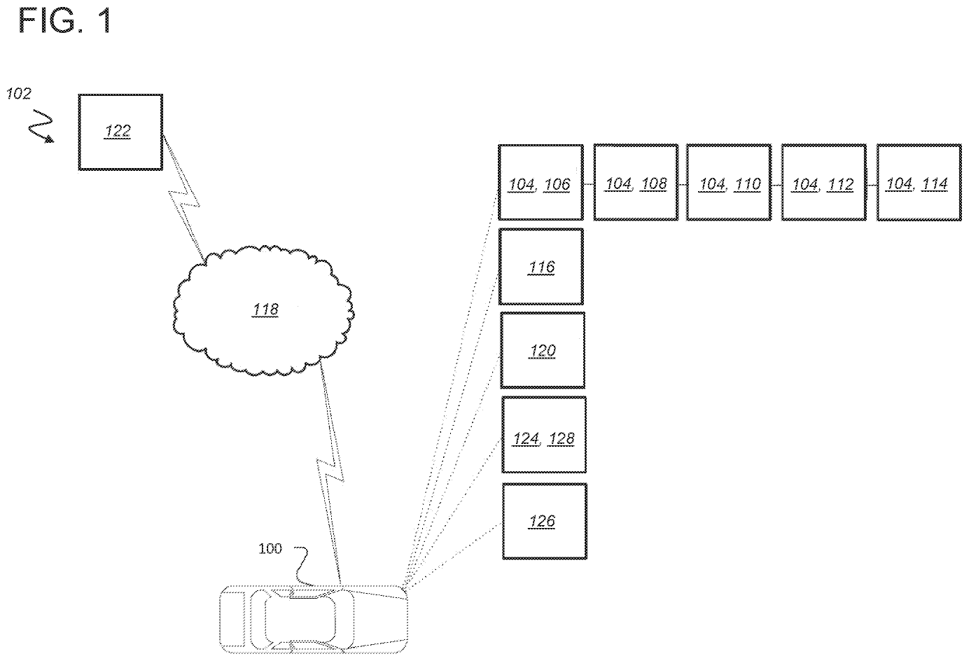

Referring to FIG. 1, one non-limiting example of a motor vehicle 100 includes a vehicle control system 102 (system). The vehicle 100, is a land vehicle such as a car, truck, etc. The system 102 includes one or more perception sensors 104 attached to the motor vehicle 100. The perception sensors 104 generate sensor data, in response to the perception sensors 104 detecting a vehicle condition, e.g., the motor vehicle 100 approaching a traffic signal, a Vulnerable Road User, or a third party vehicle. Non-limiting examples of the perception sensors 104 include a camera 106, e.g. a front view, a side view, a rear view, etc., providing images from a field of view inside and/or outside the vehicle 100. The perception sensors 104 may further include one or more light detection and ranging sensors 108 (LiDAR), disposed on a top of the vehicle 100, behind a vehicle front windshield, around the vehicle 100, etc., that provide relative locations, sizes, and shapes of objects and/or conditions surrounding the vehicle 100. The perception sensors 104 may further include one or more radar sensors 104 that are fixed to vehicle bumpers to provide data and range a velocity of objects (possibly including third party vehicles), etc., relative to the location of the vehicle 100. Still, in other non-limiting examples, it is contemplated that the perception sensors 104 may further include a global navigation satellite device 110, an inertial measuring unit 112, an ultrasonic sensor 114, or any combination thereof to provide sensor data.

The system 102 further includes a vehicle communication module 116 that uses a vehicle communications network 118 to allow a computer 120 to communicate with a server 122. More specifically, the computer 120 uses the vehicle communications network 118 to transmit messages, wired or wirelessly, to various output devices in the vehicle 100 and/or receive messages from the devices, e.g., the perception sensors 104, output devices 124, a human machine interface (HMI), etc. The network 118 can include a bus or the like in the vehicle 100 such as a controller area network (CAN) or the like, and/or other wired and/or wireless mechanisms. Alternatively or additionally, in cases where the computer 120 includes a plurality of devices, the vehicle 100 communications network may be used for communications between devices represented as the computer 120 in this disclosure. Further, as mentioned below, various processors and/or perception sensors 104 may provide data to the computer 120.

The network 118 includes one or more mechanisms by which the computer 120 may communicate with the server 122. Accordingly, the network 118 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

The vehicle communication module 116 can be a vehicle to vehicle communication module or interface with devices outside of the vehicle 100, e.g., through a vehicle to vehicle (V2V) or vehicle-to-infrastructure (V2X) wireless communications to another vehicle, to a remote server 122 (typically via the network 118). The module 116 could include one or more mechanisms by which the computer 120 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 116 include cellular, Bluetooth®, IEEE 802.11, dedicated short range communications (DSRC), and/or wide area networks (WAN), including the Internet, providing data communication services.

The server 122 can be a computing device, i.e., including one or more processors and one or more memories, programmed to provide operations such as disclosed herein. Further, the server 122 can be accessed via the network 118, e.g., the Internet or some other wide area network.

The computer 120 can receive and analyze data from the perception sensors 104 substantially continuously, periodically, and/or when instructed by a server 122, etc. Further, object classification or identification techniques can be used, e.g., in a computer 120 based on the camera 106, the lidar sensor 108, etc., data, to identify a type of object, e.g., vehicle, person, rock, pothole, bicycle, motorcycle, etc., as well as physical features of objects.

Each of the output devices 124 performs an action, in response to the output device 124 receiving an output signal from the computer 120 as described below. In the context of the present disclosure, an output device 124 is one or more hardware components adapted to perform a mechanical or electro-mechanical function or operation, such as moving the vehicle 100, slowing or stopping the vehicle 100, steering the vehicle 100, etc. Non-limiting examples of components 126 include a propulsion component (that includes, e.g., an internal combustion engine and/or an electric motor, hydrogen fuel cell, etc.), a transmission component, a steering component (e.g., that may include one or more of a steering wheel, a steering rack, etc.), a brake component (as described below), a park assist component, an adaptive cruise control component, an adaptive steering component, a movable seat, etc. One non-limiting example of the output device 124 can include a lateral/longitudinal control module 128 for controlling at least one of a lateral movement and a lateral movement of the motor vehicle 100, in response to the lateral/longitudinal control module 128 receiving the output signal from the processor. Other non-limiting examples of the output devices 124 can include brakes, a propulsion system (e.g., control of acceleration in the vehicle by controlling one or more of an internal combustion engine, electric motor, hybrid engine, hydrogen-fuel cell, etc.), steering, climate control, interior and/or exterior lights, etc., as well as to a controller determining whether and when the computer, as opposed to a human operator, is to control such operations.

Additionally, the computer 120 may be programmed to determine whether and when a human operator is to control such operations. The output devices 124 can be implemented via circuits, chips, motors, or other electronic and or mechanical components that can actuate various vehicle subsystems, in response to the output device 124 receiving the output signal from the computer 120. Continuing with the previous non-limiting example, the output devices 124 may control components, including braking, acceleration, and steering of a vehicle 100.

The computer 120 coupled to the perception sensors 104 and operating the motor vehicle 100 in an autonomous mode, a semi-autonomous mode, or a non-autonomous (manual) mode. For purposes of this disclosure, an autonomous mode is defined as one in which each of vehicle 100 propulsion, braking, and steering are controlled by the computer 120; in a semi-autonomous mode the computer 120 controls one or two of vehicles propulsion, braking, and steering; in a non-autonomous mode, a human operator controls each of vehicle 100 propulsion, braking, and steering. It is contemplated that the computer can perform any other suitable vehicle operation.

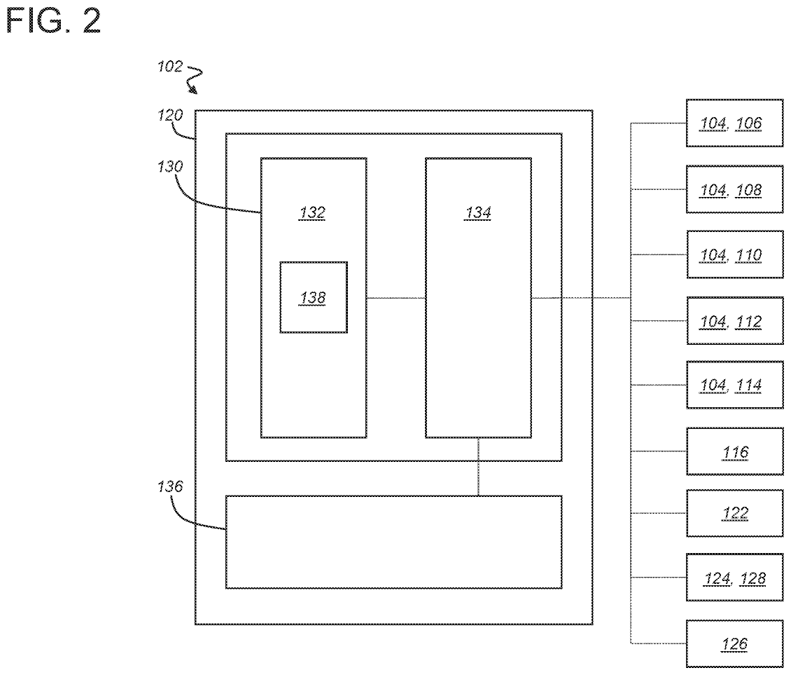

As best shown in the non-limiting example of FIG. 2, the computer 120 includes one or more processors 130 coupled to the perception sensors 104 for receiving sensor data from the perception sensors 104 (FIG. 1). The processor 130 includes a Trusted Execution Environment 132 (TEE) and a Rich Execution Environment 134 (REE). The TEE 132 generally offers an execution space that provides a higher level of security for trusted models running on the processor 130 than the REE operating system as described in detail below.

More specifically, in this non-limiting example, the REE 134 requires a first amount of memory for operating at a first speed. The REE 134 provides an operating environment with a set of features for platforms, such as ANDROID, IOS, WINDOWS, LINUX, OS X or any suitable operating system. Moreover, the TEE 132 is a secured space of the processor 130 that requires a second amount of memory that is smaller than the first amount of memory, such that the TEE 132 operates at a second speed that is slower than the first speed of the REE 134. The TEE 132 provides a combination of features, both software and hardware, which provides the secured space of the processor 130. Non-limiting examples of these security features include isolated execution to protect processing, memory, and storage capabilities, such that the TEE 132 provides integrity of models executed within the TEE 132 and confidentiality of the data and models operated therein. The TEE 132 requires hardware support to provide protection from the REE 134, and the TEE operating system manages the security hardware and provides a means to communicate between the TEE 132 and REE 134. The TEE 132 is separate from the REE operating system where adversaries may extract unencrypted models.

The computer 120 further includes a non-transitory computer readable storage medium 136 (“CRM”). The CRM 136 includes one or more forms of computer readable media, and stores instructions executable by the computer 120 for performing various operations, including as disclosed herein.

Further, in this non-limiting example, the vehicle 100 (FIG. 1) can be referred to as an agent. The computer 120 is configured to implement a neural network-based reinforcement learning procedure as described herein. The computer 120 generates a set of state-action values (Q-values) as outputs for an observed input state. The computer 120 can select an action corresponding to a maximum state-action value, e.g., the highest state-action value. The computer 120 obtains sensor data from the perception sensors 104 that corresponds to an observed input state.

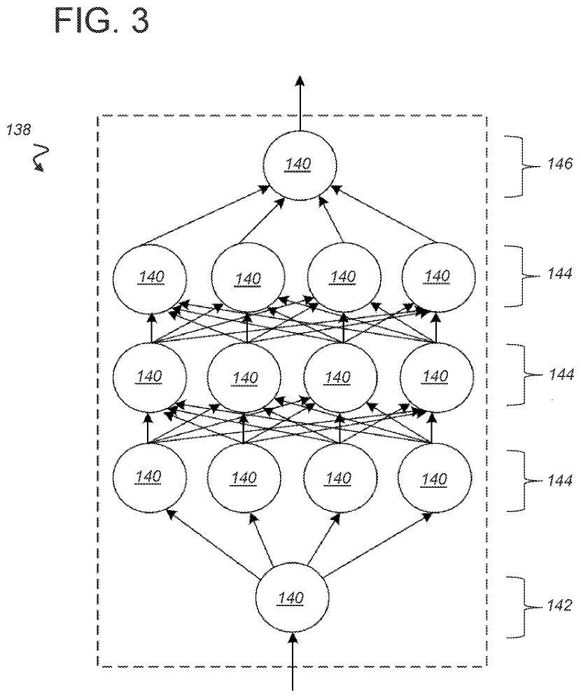

Referring now to FIG. 3, the computer utilizes a deep neural network (DNN) 138 for controlling a vehicle operation. The DNN 138 can be a software program that can be loaded in CRM 136 (FIG. 2) and executed by the processor 130 included in the computer 120, for example. In more practical terms, the DNN 138 is a non-linear statistical data modeling or decision making tool. The DNN 138 can be used to model complex relationships between inputs and outputs or to find patterns in data.

The DNN 138 can include any suitable neural network capable of employing statistical learning techniques. In this non-limiting example, the DNN 138 is a convolutional neural network 118 (CNN). The DNN 138 includes multiple neurons 140, and the neurons 140 are arranged so that the DNN 138 includes an input layer 142, one or more hidden layers 144, and an output layer 146. Each layer of the DNN 138 can include a plurality of neurons 140. While FIG. 3 illustrates three (3) hidden layers 144, it is understood that the DNN 138 can include additional or fewer hidden layers. The input and output layers 142, 146 may also include more than one (1) neuron 140.

The neurons 140 are sometimes referred to as artificial neurons 140, because they are designed to emulate biological, e.g., human, neurons. A set of inputs (represented by the arrows) to each neuron 140 are each multiplied by respective weights. The weighted inputs can then be summed in an input function to provide, possibly adjusted by a bias, a net input. The net input can then be provided to activation function, which in turn provides a connected neuron 140 an output. The activation function can be a variety of suitable functions, typically selected based on empirical analysis. As illustrated by the arrows in FIG. 3, neuron 140 outputs can then be provided for inclusion in a set of inputs to one or more neurons 140 in a next layer.

The DNN 138 can be trained to accept sensor data from the perception sensors 104 (FIG. 1), e.g., from a vehicle CAN bus or other network, as input and generate a state-action value, e.g., reward value, based on the input. The DNN 138 can be trained with training data, e.g., a known set of sensor inputs, to train the agent for the purposes of determining an optimal policy. In one or more implementations, the DNN 138 is trained via a server 122 (FIG. 1), and the trained DNN 138 can be transmitted to the vehicle 100 via the network 118. Weights can be initialized by using a Gaussian distribution, for example, and a bias for each neuron 140 can be set to zero. Training the DNN 138 can including updating weights and biases via suitable techniques such as back-propagation with optimizations.

Referring back to FIG. 2, the CRM 136 stores instructions such that the processor 130 is programmed to initialize the system 102 (FIG. 1) where the processor 130 homomorphically encrypts a non-encrypted DNN in the TEE 132. The processor 130 is further programmed to transfer the homomorphically encrypted DNN from the TEE 132 to the REE 134. The processor 130 is further programmed to receive, in the TEE 132 of the processor 130, the sensor data from the perception sensor 104. The processor 130 is further programmed to homomorphically encrypt the sensor data in the TEE 132 and transfer the sensor data from the TEE 132 to the REE 134. The processor 130 is further programmed to pre-process the sensor data in the TEE 132, homomorphically encrypt the pre-processed sensor data in the TEE 132, and transfer the encrypted sensor data from the TEE 132 to the REE 134. In one non-limiting example where the processor receives sensor data from the camera 106, the processor 130 pre-processes the sensor data by converting an image based on the sensor data from an RGB format to a distinct format such as YUV format or other suitable image format. The processor 130 is further programmed to use the homomorphically encrypted neural network in the REE 134 to calculate an encrypted output based on the encrypted sensor data in the REE 134 and a plurality of weights. The processor 130 is further programmed to transfer the encrypted output from the REE 134 to the TEE 132 and homomorphically decrypt the encrypted output in the TEE 132. In this non-limiting example, the processor 130 is further programmed to post-process the decrypted output in the TEE 132 and transfer the decrypted output from the TEE 132 to the REE 134. The processor 130 is further programmed to generate the output signal in the REE 134 based on the decrypted output, such that the output device 124 performs the action in response to the output device 124 receiving the output signal.

In another non-limiting example, a system having two or more computers is similar to the computer 120 of FIG. 2 and has the same components identified by the same numbers increased by 100. However, while the system 102 of FIG. 2 includes a single computer 120 for processing one input, this exemplary system includes two or more computers collaborating with one another for processing multiple units. The computer may include or be communicatively coupled to, e.g., via the vehicle communication module 116, more than one other computer or processor, e.g., included in electronic controller units (ECUs) or the like included in the vehicle for monitoring and/or controlling various output devices, e.g., a powertrain controller, a brake controller, a steering controller, etc. Further, the computer may communicate, via a vehicle communications module, with a navigation system that uses the Global Position System (GPS). As an example, the computer may request and receive location data of the vehicle. The location data may be in a known form, e.g., geo-coordinates (latitudinal and longitudinal coordinates).

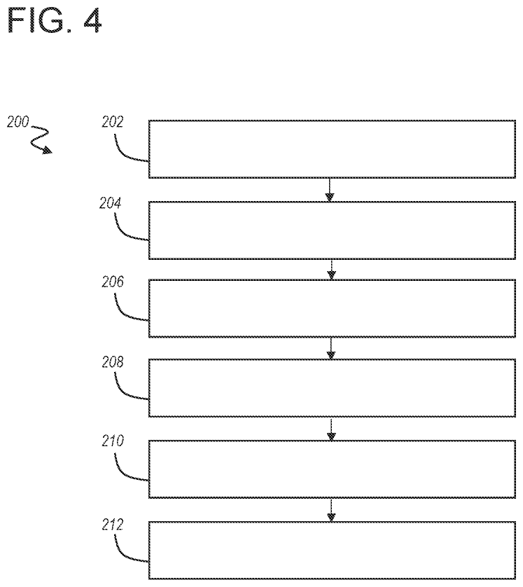

Referring to FIG. 4, one non-limiting example of a process 200 for operating the system 102 of FIG. 1 begins at block 202 with initializing, using the processor 130, the system 102 where the processor 130 homomorphically encrypts a non-encrypted DNN in the TEE 132. The process 200 further includes transferring, using the processor 130, the homomorphically encrypted DNN from the TEE 132 to the REE 134.

At block 204, the process 200 further includes receiving, in the TEE 132 of the processor 130, the sensor data from the perception sensor 104. The process 200 further includes transferring the sensor data from the TEE 132 to the REE 134 and homomorphically encrypt the sensor data in the TEE 132. During operation, the computer 120 obtains sensor data from the perception sensors 104 and provides the data as input to the DNN 138. As described in detail below, once trained, the DNN 138 can accept the sensor input and provide, as output, one or more state-action values (Q-values) based on the sensed input. During execution of the DNN 138, the state-action values can be generated for each action available to the agent within the environment.

At block 206, the process 200 further includes pre-processing, using the processor 130, the sensor data in the TEE 132, homomorphically encrypting the pre-processed sensor data in the TEE 132, and transferring the encrypted sensor data from the TEE 132 to the REE 134. In one non-limiting example where the processor 130 receives sensor data from the camera 106, the processor 130 pre-processes the sensor data by converting an image based on the sensor data from the RGB format to a distinct format such as YUV format or other suitable image format.

At block 208, the process 200 further includes the homomorphically encrypted neural network in the REE 134 for calculating the encrypted output based on the encrypted sensor data in the REE 134 and a plurality of weights.

At block 210, the process 200 further includes transferring, using the processor 130, the encrypted output from the REE 134 to the TEE 132 and homomorphically decrypting the encrypted output in the TEE 132. In this non-limiting example, the processor 130 is further programmed to post-process the decrypted output in the TEE 132 and transferring the decrypted pre-processed output from the TEE 132 to the REE 134.

At block 212, the process 200 further includes generating, using the processor 130, the output signal in the REE 134 based on the decrypted output, such that the output device 124 performs the action in response to the output device 124 receiving the output signal.

Computers and computing devices generally include computer executable instructions, where the instructions may be executable by one or more computing devices such as those listed above. Computer executable instructions may be compiled or interpreted from computer programs created using a variety of programming languages and/or technologies, including, without limitation, and either alone or in combination, JAVA, C, C++, MATLAB, SIMULINK, STATEFLOW, VISUAL BASIC, JAVA SCRIPT, PERL, HTML, TENSORFLOW, PYTHON, PYTORCH, KERAS, etc. Some of these applications may be compiled and executed on a virtual machine, such as the JAVA virtual machine, the DALVIK virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

The CRM (also referred to as a processor readable medium) participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

In some examples, system elements may be implemented as computer readable instructions (e.g., software) on one or more computing devices, stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A computer for a system of a motor vehicle, the system including at least one perception sensor generating sensor data and at least one output device performing an action in response to the at least one output device receiving an output signal, the computer comprising:
at least one processor coupled to the at least one perception sensor and the at least one output device, with the at least one processor having a Rich Execution Environment (REE) and a Trusted Execution Environment (TEE);
and a non-transitory computer readable storage medium (CRM) including instructions such that the at least one processor is programmed to:
receive, in the REE, the sensor data from the at least one perception sensor;
calculate an encrypted output based on the sensor data in the REE and at least a plurality of weights of a homomorphically encrypted neural network in the REE;
transfer the encrypted output from the REE to the TEE;
homomorphically decrypt the encrypted output in the TEE; and
transfer the decrypted output from the TEE to the REE.

2. The computer of claim 1 wherein the REE requires a first amount of memory and the TEE is secured and requires a second amount of memory that is smaller than the first amount of memory.

3. The computer of claim 2 wherein the at least one processor is further programmed to:
transfer the sensor data from the REE to the TEE;
homomorphically encrypt the sensor data in the TEE; and
transfer the encrypted sensor data from the TEE to the REE.

4. The computer of claim 2 wherein the at least one processor is further programmed to post-process the decrypted output in the TEE.

5. The computer of claim 2 wherein the at least one processor is further programmed to generate the output signal in the REE based on the decrypted output, such that the at least one output device performs the action in response to the at least one output device receiving the output signal.

6. The computer of claim 5 wherein the at least one processor is further programmed to initialize the system where the at least one processor:
homomorphically encrypts a non-encrypted neural network in the TEE to produce the homomorphically encrypted neural network; and
transfer the homomorphically encrypted neural network from the TEE to the REE.

7. The computer of claim 6 wherein the at least one processor is further programmed to pre-process the sensor data in the TEE.

8. The computer of claim 7 wherein the at least one processor is further programmed to homomorphically encrypt the pre-processed sensor data in the TEE.

9. The computer of claim 7 wherein pre-processing the sensor data comprises converting an image from an RGB format to a YUV format.

10. A system for a motor vehicle, the system comprising:
at least one perception sensor attached to the motor vehicle and generating sensor data;
at least one computer coupled to the at least one perception sensor, with the at least one computer comprising:
at least one processor coupled to the at least one perception sensor, with the at least one processor having a Rich Execution Environment (REE) and a Trusted Execution Environment (TEE); and
a non-transitory computer readable storage medium (CRM) including instructions such that the at least one processor is programmed to:
receive, in the REE, the sensor data from the at least one perception sensor;
calculate an encrypted output based on the sensor data in the REE and at least a plurality of weights of a homomorphically encrypted neural network in the REE;
transfer the encrypted output from the REE to the TEE;
homomorphically decrypt the encrypted output in the TEE; and
transfer the decrypted output from the TEE to the REE; and
at least one output device coupled to the at least one processor and performing an action in response to the at least one output device receiving an output signal from the at least one processor.

11. The system of claim 10 wherein the at least one processor is further programmed to initialize the system where the at least one processor:
homomorphically encrypts a non-encrypted neural network in the TEE to produce the homomorphically encrypted neural network; and
transfer the homomorphically encrypted neural network from the TEE to the REE.

12. The system of claim 11 wherein the at least one perception sensor comprises at least one of a camera, a lidar sensor, a radar sensor, a global navigation satellite device, an inertial measuring unit, and an ultrasonic sensor.

13. The system of claim 12 wherein the at least one processor is further programmed to:
pre-process the sensor data in the TEE; and
homomorphically encrypt the pre-processed sensor data in the TEE.

14. The system of claim 12 wherein the sensor data comprises an image in RGB format captured by the camera, wherein pre-processing the sensor data comprises converting the image from the RGB format to a YUV format.

15. The system of claim 12 wherein the at least one output device comprises a lateral/longitudinal control module for controlling at least one of a lateral movement and a lateral movement of the motor vehicle in response to the lateral/longitudinal control module receiving the output signal from the at least one processor.

16. The system of claim 15 wherein the at least one processor is further programmed to:
transfer the sensor data from the REE to the TEE;
homomorphically encrypt the sensor data in the TEE; and
transfer the encrypted sensor data from the TEE to the REE, such that the processor calculates the encrypted output based on the encrypted sensor data.

17. The system of claim 10 wherein the at least one processor is further programmed to post-process the decrypted output in the TEE.

18. The system of claim 17 wherein the at least one processor is further programmed to generate the output signal in the REE based on the decrypted output, such that the at least one output device performs the action in response to the at least one output device receiving the output signal.

19. A process of operating a system for a motor vehicle, the system including at least one perception sensor attached to the motor vehicle, at least one output device attached to the motor vehicle, and at least one computer coupled to the at least one perception sensor and at least one output device, each of the at least one computer including at least one processor and a non-transitory computer readable storage medium storing instructions, the process comprising:
generating, using the at least one perception sensor, sensor data;
receiving, using the REE of the at least one processor, the sensor data from the at least one perception sensor;
transferring, using the at least one processor, the sensor data from the TEE to the REE;
homomorphically encrypting, using the at least one processor, the sensor data in the TEE;
transferring, using the at least one processor, the encrypted sensor data from the TEE to the REE;
calculating, using the at least one processor, an encrypted output based on the encrypted sensor data in the REE and at least a plurality of weights of a homomorphically encrypted neural network in the REE; and
performing, using the at least one output device, an action in response to the at least one output device receiving an output signal from the at least one processor.

20. The process as recited in claim 19, further comprising:
initializing, using the at least one processor, the system where the at least one processor:
homomorphically encrypts a non-encrypted neural network in the TEE to produce the homomorphically encrypted neural network; and
transfer the homomorphically encrypted neural network from the TEE to the REE;
pre-processing, using the at least one processor, the sensor data in the TEE;
homomorphically encrypting, using the at least one processor, the pre-processed sensor data in the TEE;
transferring, using the at least one processor, the encrypted output from the REE to the TEE;
homomorphically decrypting, using the at least one processor, the encrypted output in the TEE;
post-processing, using the at least one processor, the decrypted output in the TEE;
transferring, using the at least one processor, the decrypted output from the TEE to the REE; and
generating, using the at least one processor, the output signal in the REE based on the decrypted output, such that the at least one output device performs the action in response to the at least one output device receiving the output signal.
